(19) United States
(12) Patent Application Publication
(10) Pub. No.: US 2017/0275928 A1
(43) Pub. Date: Sep. 28, 2017

(54) Childproof Cabinet Latch System

(71) Applicant: Kiddopro, LLC, Estero, FL (US)

(72) Inventor: Kent A. Kozlowski, Fort Myers, FL (US)

(73) Assignee: Kiddopro, LLC

(21) Appl. No.: 15/468,959

(22) Filed: Mar. 24, 2017

Related U.S. Application Data
(60) Provisional application No. 62/313,904, filed on Mar. 28, 2016.

(51) Int. Cl. E05B 65/00; E05C 17/12; E05B 65/46; E05C 19/06

(52) U.S. Cl. CPC E05B 65/0014; E05C 19/06; E05C 17/12; E05B 65/46

(57) ABSTRACT

A childproof cabinet latch system for effectively securing cabinet doors and drawers without damaging wood surfaces. The childproof cabinet latch system generally includes a base, a latch extending outwardly from the base, a catch portion that is adapted to catchably engage an interior surface of a cabinet surrounding an opening in the cabinet, a slot extending through the base, and an opening extending through the base and connected to the slot, wherein the width of the first opening is greater than the width of the first slot. The width of the first opening is also greater than a width of a head of a threaded fastener to allow passage of the head of the threaded fastener through the first opening. The width of the first slot is less than the width of the head of the threaded fastener to prevent passage of the head through the first slot.

### CROSS REFERENCE TO RELATED APPLICATIONS

I hereby claim benefit under Title 35, United States Code, Section 119(e) of U.S. provisional patent application Ser. No. 62/313,904 filed Mar. 28, 2016 (Docket No. KOZL-001). The 62/313,904 application is currently pending. The 62/313,904 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a childproof cabinet latch system for effectively securing cabinet doors and drawers without damaging wood surfaces.

### Related Art

Any discussion of the related art throughout the specification should in no way be considered as an admission that such related art is widely known or forms part of common general knowledge in the field.

Childproof cabinet latches or safety latches have been in use to prevent children from opening doors and/or drawers of cabinets for safety reasons. Conventional safety latches are attached to the interior surface of the door or drawer of the cabinet with a fastener such as a screw, adhesive or glue. A problem with conventional safety latches is that they damage the interior surface of the door or drawer of the cabinet when they are attached or removed. Hence, once the household no longer needs the safety latches, removal of the safety latches results in an undesirable appearance for the interior surface of the door and drawers of the cabinets.

### SUMMARY

An example embodiment is directed to a childproof cabinet latch system. The childproof cabinet latch system includes a base, a latch extending outwardly from the base, a catch portion that is adapted to catchably engage an interior surface of a cabinet surrounding an opening in the cabinet, a slot extending through the base, and an opening extending through the base and connected to the slot, wherein the width of the first opening is greater than the width of the first slot. The width of the first opening is also greater than a width of a head of a threaded fastener to allow passage of the head of the threaded fastener through the first opening. The width of the first slot is less than the width of the head of the threaded fastener to prevent passage of the head through the first slot.

There has thus been outlined, rather broadly, some of the embodiments of the childproof cabinet latch system in order that the detailed description thereof may be better understood, and in order that the present contribution to the art may be better appreciated. There are additional embodiments of the childproof cabinet latch system that will be described hereinafter and that will form the subject matter of the claims appended hereto. In this respect, before explaining at least one embodiment of the childproof cabinet latch system in detail, it is to be understood that the childproof cabinet latch system is not limited in its application to the details of construction or to the arrangements of the components set forth in the following description or illustrated in the drawings. The childproof cabinet latch system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a childproof cabinet latch system in accordance with an example embodiment.

FIG. 2a is a front view of a childproof cabinet latch system in accordance with an example embodiment.

FIG. 2b is a rear view of a childproof cabinet latch system in accordance with an example embodiment.

FIG. 3a is a right side view of a childproof cabinet latch system in accordance with an example embodiment.

FIG. 3b is a left side view of a childproof cabinet latch system in accordance with an example embodiment.

FIG. 4a is a top view of a childproof cabinet latch system in accordance with an example embodiment.

FIG. 4b is a bottom view of a childproof cabinet latch system in accordance with an example embodiment.

FIG. 5 is a perspective view of a childproof cabinet latch system in accordance with an example embodiment.

FIG. 6a is a front view of a childproof cabinet latch system in accordance with an example embodiment.

FIG. 6b is a rear view of a childproof cabinet latch system in accordance with an example embodiment.

FIG. 7 is a perspective view of a childproof cabinet latch system used with a cabinet in accordance with an example embodiment.

FIG. 8a is a magnified perspective view of a childproof cabinet latch system prior to being attached to a door of a cabinet in accordance with an example embodiment.

FIG. 8b is a magnified perspective view of a childproof cabinet latch system with the threaded fastener of the door of the cabinet being loosened in accordance with an example embodiment.

FIG. 8c is a magnified perspective view of a childproof cabinet latch system being positioned about the loosened threaded fastener in accordance with an example embodiment.

FIG. 8d is a magnified perspective view of a childproof cabinet latch system being moved to a desired location within the slot in accordance with an example embodiment.

FIG. 8e is a magnified perspective view of a childproof cabinet latch system being further moved to a desired location within the slot in accordance with an example embodiment.

FIG. 8f is a magnified perspective view of a childproof cabinet latch system with the threaded fastener for the handle of the door being tighted in accordance with an example embodiment.

FIG. 9a is a side cutaway view of a childproof cabinet latch system used in conjunction with a closed door and drawer of a cabinet in accordance with an example embodiment.

FIG. 9b is a side cutaway view of a childproof cabinet latch system used in conjunction with a door and drawer of a cabinet with the door and drawer partially opened but prevented from opening fully in accordance with an example embodiment.

FIG. 9c is a side cutaway view of a childproof cabinet latch system used in conjunction with a door and drawer of a cabinet with the latch released so the door and drawer may be opened in accordance with an example embodiment.

### DETAILED DESCRIPTION

### A. Overview

An example childproof cabinet latch system generally comprises a base 20, a latch 70 extending outwardly from the base 20, a catch portion 76 that is adapted to catchably engage an interior surface of a cabinet 10 surrounding an opening in the cabinet 10, a slot extending through the base 20, and an opening extending through the base 20 and connected to the slot, wherein the width of the first opening 52 is greater than the width of the first slot 50. The width of the first opening 52 is also greater than a width of a head 19 of a threaded fastener 18 to allow passage of the head 19 of the threaded fastener 18 through the first opening 52. The width of the first slot 50 is less than the width of the head 19 of the threaded fastener 18 to prevent passage of the head 19 through the first slot 50.

The base 20 and latch 70 are preferably comprised of a resilient plastic material, however, various other materials and structures may be utilized to construct the base 20 and latch 70 such as metal, composite and the like. The base 20 and the latch 70 are further preferably constructed of a unitary structure comprised of a single material type, however, various other structures may be used to construct the base 20 and the latch 70. Furthermore, the base 20 and latch 70 may be constructed of different material types.

### B. Base

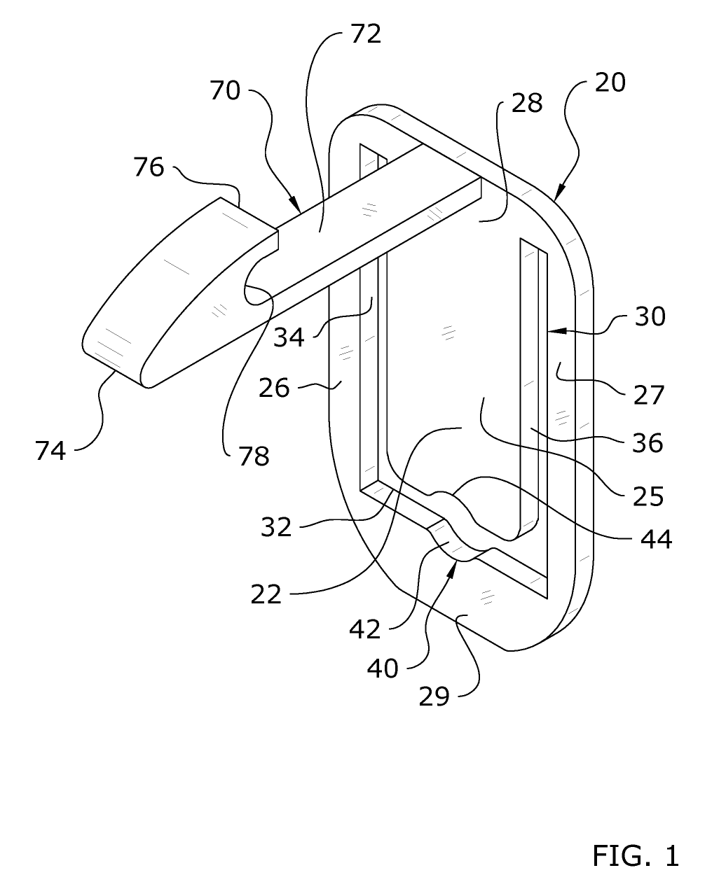

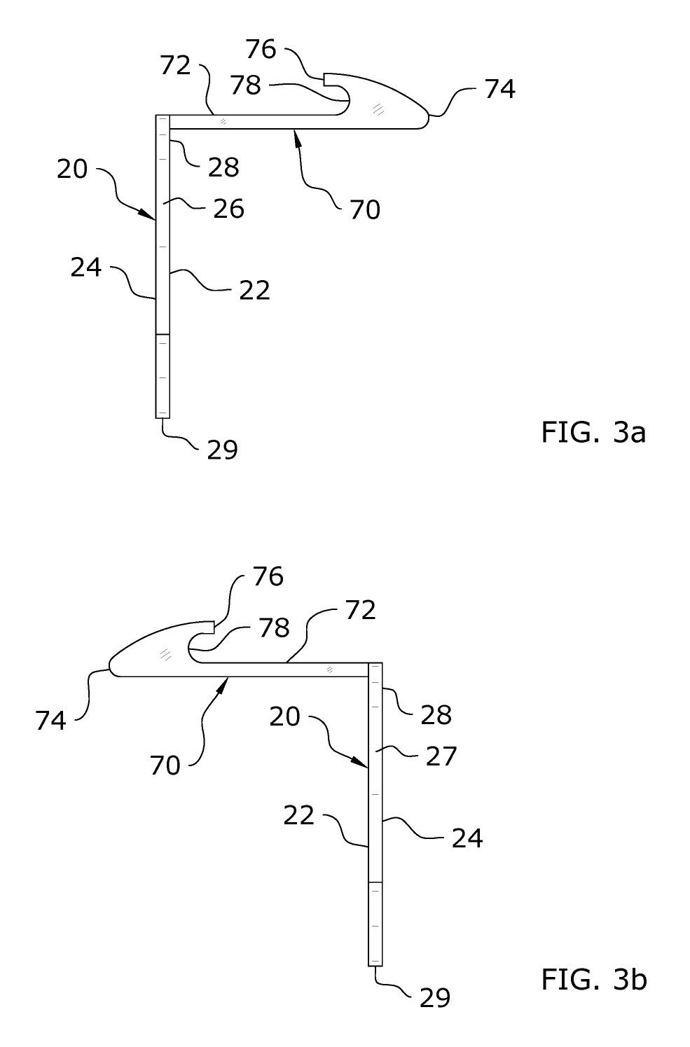

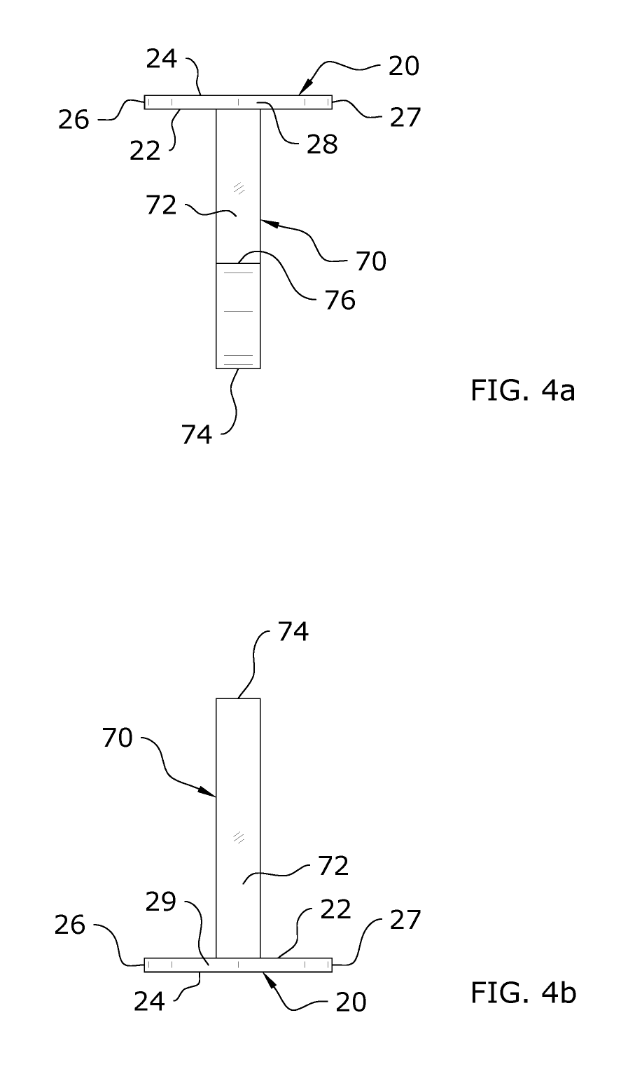

In the various embodiments illustrated in FIGS. 1 through 8b of the drawings, the base 20 preferably has an outer surface 22, an inner surface 24 opposite of the outer surface 22, a first side portion 26, a second side portion 27 opposite of the first side portion 26, an upper portion 28, and a lower portion 29 opposite of the upper portion 28. The outer surface 22 is preferably parallel with respect to the inner surface 24 as illustrated in FIGS. 3a and 3b of the drawings, but the respective surfaces may have non-parallel alignment. The base 20 is further preferably comprised of a flat plate structure but other non-plate structures may be used. The base 20 may have various thicknesses but preferably has a thickness of ⅛ of an inch or less so that the threaded fastener 18 still has a significant portion of threading that is threadably connected to the handle 16 of the door 14 or drawer 12 of the cabinet 10. The base 20 is comprised of a rigid material and structure to provide support for the latch 70.

The base 20 may be comprised of various shapes such as, but not limited to, rectangular, circular, oval, polygonal, triangular and the like. If the base 20 has a rectangular shape as illustrated in FIGS. 1, 2a, 2b, 6a and 6b of the drawings, the length of the base 20 measured from a lower edge to an upper edge is preferably greater than a width of the base 20 measured from a first side edge to a second side edge. However, it can be appreciated that the horizontal width of the base 20 may be greater than the vertical length.

### C. Latch

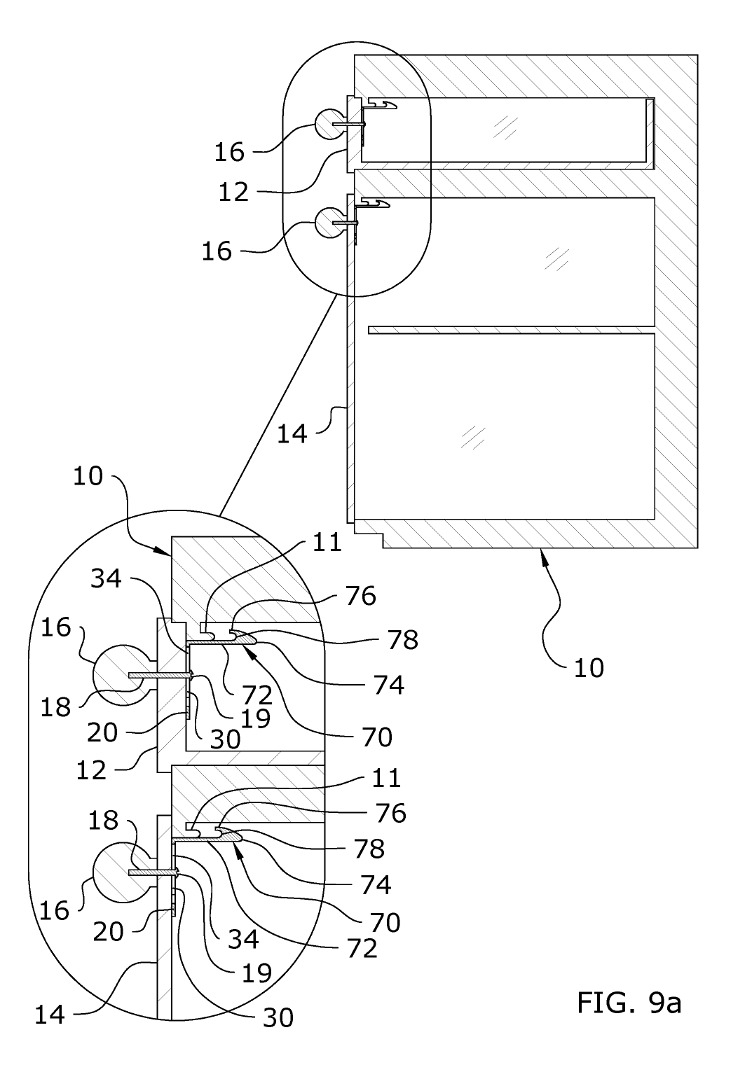

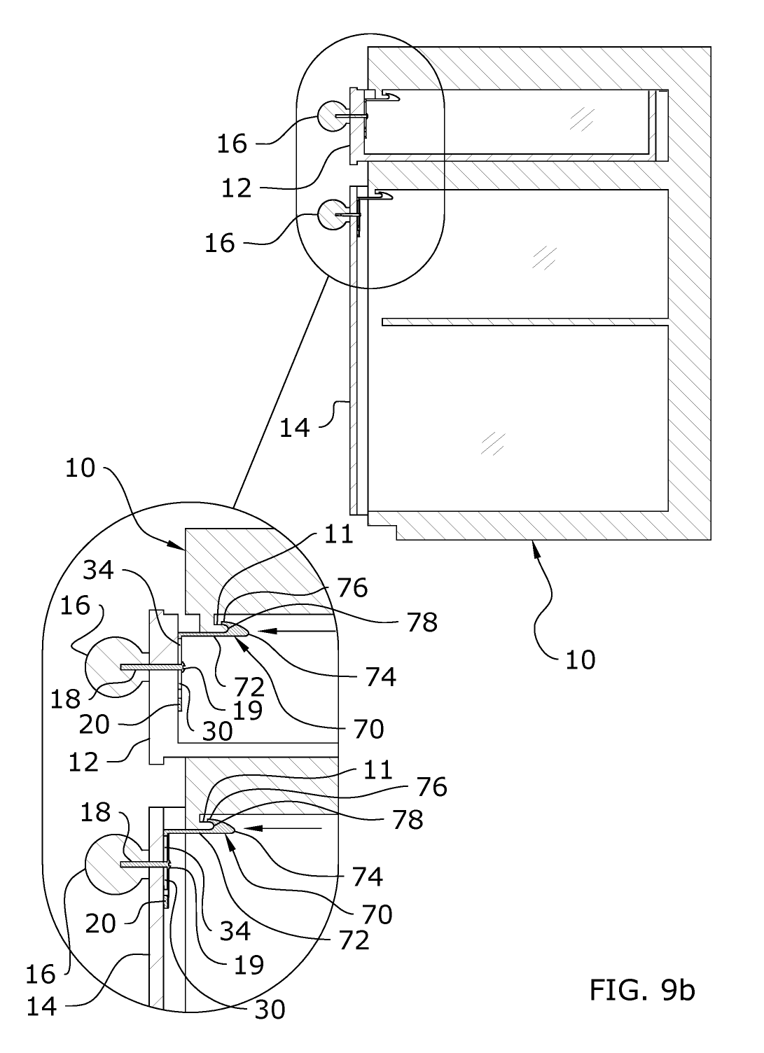

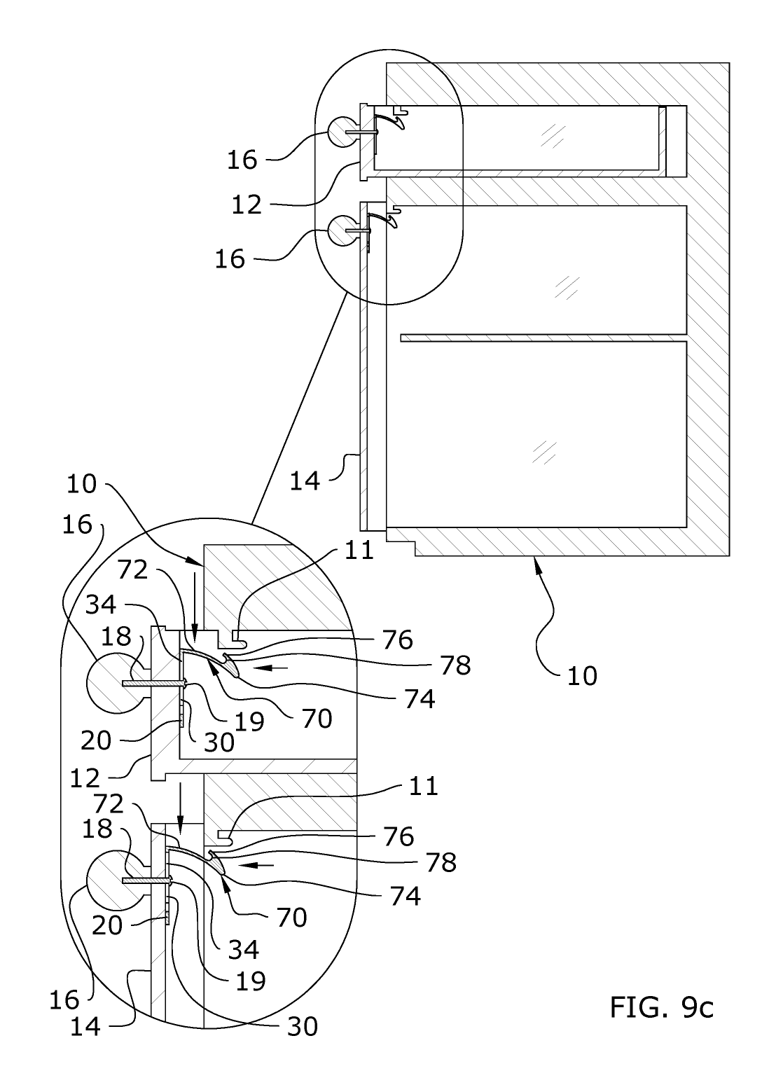

In the various embodiments, the latch 70 extends outwardly from the base 20 (e.g. the outer surface 22 or an edge) as illustrated in FIGS. 1, 3a, 3b and 5 of the drawings. The latch 70 is adapted to selectively catch an interior surface of the cabinet 10 that surrounds the opening in the cabinet 10 for the door 14 or drawer 12. The latch 70 may have various configurations and structures capable of catchably engaging a portion of the cabinet 10 to prevent the full opening of the door 14 or drawer 12 of the cabinet 10. The latch 70 may be connected to the door 14 or drawer 12 of the cabinet 10 in a manner that allows the latch 70 to selectively engage and disengage from an upper portion 28 of the cabinet 10 (as shown in FIGS. 9a through 9c) or a side portion of the cabinet 10.

In one embodiment, the latch 70 may be comprised of an elongated tongue 72 that includes a catch portion 76 extending from a distal portion 74 of the latch 70, wherein the catch portion 76 is adapted to catchably engage the interior surface of the cabinet 10. The elongated tongue 72 is preferably comprised of a resilient material such as, but not limited to, plastic or spring metal. When the elongated tongue 72 is comprised of a resilient material, the tongue 72 is able to be pushed downwardly (or to the side) away from the interior surface of the cabinet 10 by the hand of an adult to disengage the latch 70 from the cabinet 10 to allow for opening of the door 14 or drawer 12. The catch portion 76 preferably extends upwardly and rearwardly from the distal portion 74 forming a catch cutout 78 that removably receives an inner lip 11 of the cabinet 10 surrounding the drawer 12 or door 14. The catch portion 76 is preferably tapered to automatically pass under the edge of the opening in the cabinet 10 as best illustrated in FIGS. 3a and 3b of the drawings.

Alternatively, the elongated tongue 72 may be pivotally connected to the base 20 by a hinge with a spring connected between the base 20 and the tongue 72 to bias the elongated tongue 72 towards engagement with the interior surface of the cabinet 10 to prevent the opening of the door 14 or drawer 12 by a young child. Various other structures and devices may be utilized to construct the latch 70 other than illustrated in the drawings.

### D. Slots

One or more slots 30, 50, 60 extend through the base 20 may be used for the various embodiments of the present invention. The slots are elongated and may have various lengths, widths and shapes. For example, while the slots are preferably straight, the slots may be curved or polygonal. The slots may be horizontally aligned, vertically aligned or angled. The slots 30, 50, 60 are used to allow for adjustment of the base 20 with respect to the threaded fastener 18 used to secure the handle 16 of the door 14 or drawer 12, and correspondingly allow for adjustment of the latch 70 to accommodate various configurations of cabinets 10 without having to secure the base 20 with a separate fastener which would damage the door 14 or drawer 12.

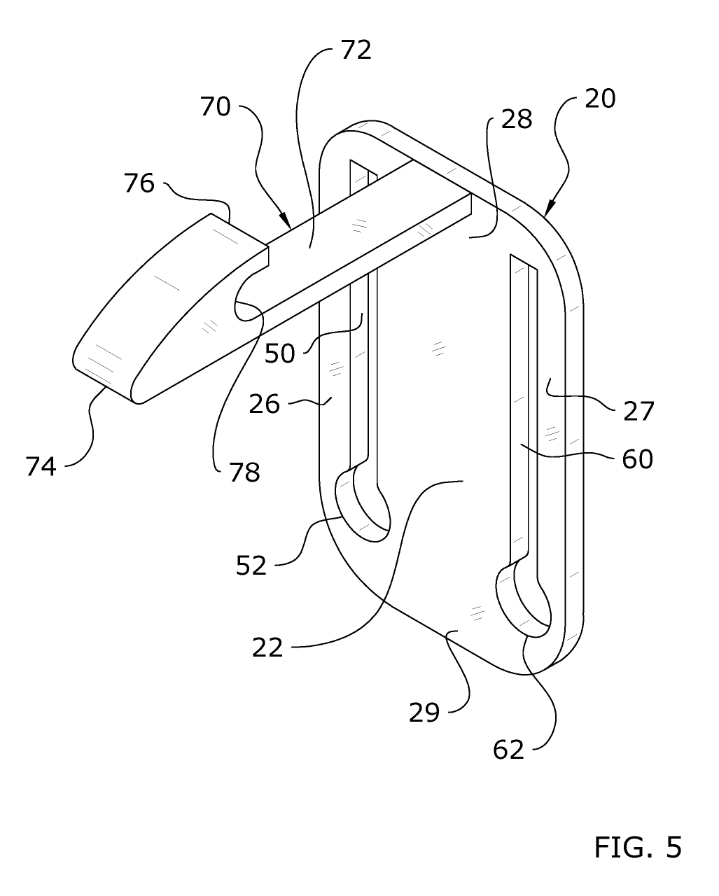

The slots preferably are completely enclosed within the outer perimeter of the base 20 to strengthen the base 20 as shown in FIGS. 1 and 5 of the drawings, but the slots may extend outside of the base 20 in some embodiments. In an embodiment where the slot extends outside of the base 20, the opening would be the open area surrounding the base 20 (in this situation the entry opening to the slot may be the same width as the slot or wider).

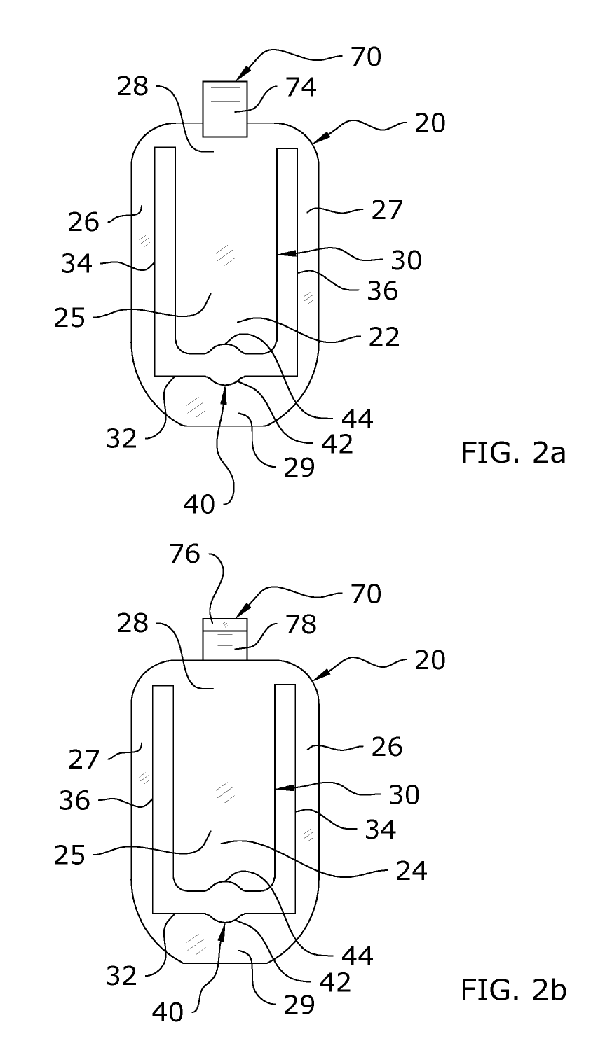

For example, FIGS. 1 through 2b illustrate an embodiment wherein the slot is comprised of a U-shaped slot 30 that extends through the base 20. The U-shaped slot 30 is generally comprised of a horizontal slot 32, a first vertical slot 34 and a second vertical slot 36 as shown in FIGS. 1 through 2b. The horizontal slot 32 is connected between the first vertical slot 34 and the second vertical slot 36. While the horizontal slot 32 is shown as being connected to the lower ends of the vertical slots 34, 36, the horizontal slot 32 may be connected between the upper ends of the vertical slots 34, 36 (not shown). Alternatively, the horizontal slot 32 may be connected to the vertical slots 34, 36 between the respective upper ends and lower ends of the vertical slots 34, 36. In addition, the horizontal slot 32 is horizontally aligned but may also be angled between the vertical slots 34, 36 (e.g. extending from the lower end of the first slot 50 to the upper end of second slot 60).

In the embodiment shown in FIGS. 1 through 2b using the U-shaped slot 30, at least one receiver opening 40 is connected to the horizontal slot 32 or one of the vertical slots 34, 36. When the receiver opening 40 is connected to the horizontal slot 32, the receiver opening 40 is preferably connected to a central portion 25 of the horizontal slot 32 though various other locations along the horizontal slot 32 are acceptable. As shown in FIGS. 1 through 2b, the receiver opening 40 may be comprised of a first cutout 42 extending into a lower edge of the horizontal slot 32 and a second cutout 44 extending into an upper edge of the horizontal slot 32. The first cutout 42 and the second cutout 44 preferably mirror one another and are positioned in opposition to one another as best illustrated in FIGS. 2a and 2b. The first cutout 42 and the second cutout 44 also preferably are each curved to receive a circular head 19 of a threaded fastener 18 (e.g. threaded screw, threaded bolt). Alternatively, the receiver opening 40 may be simply connected to the horizontal slot 32 from the lower edge or the upper edge of the horizontal slot 32.

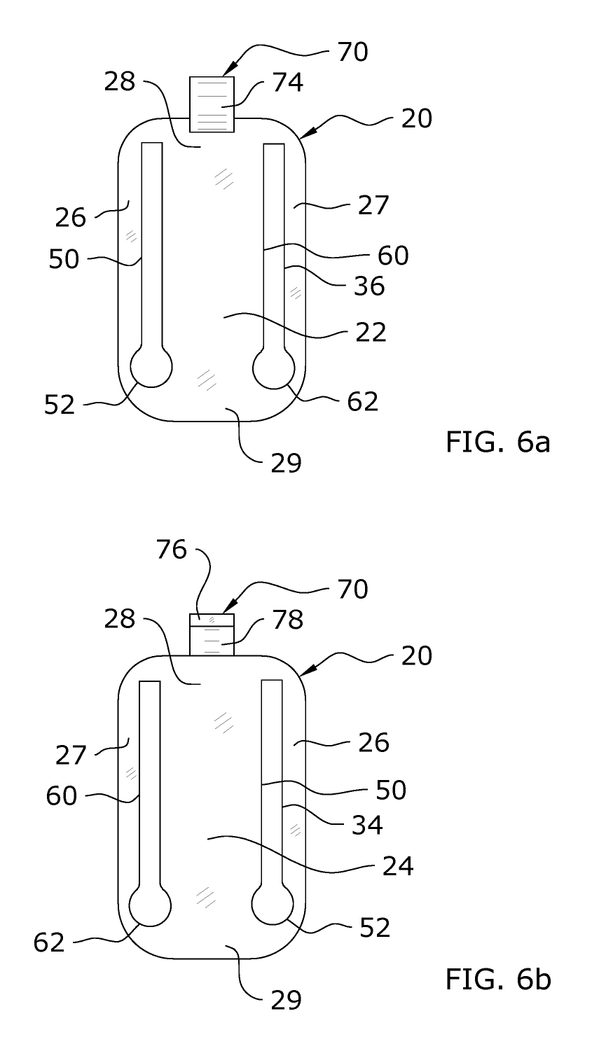

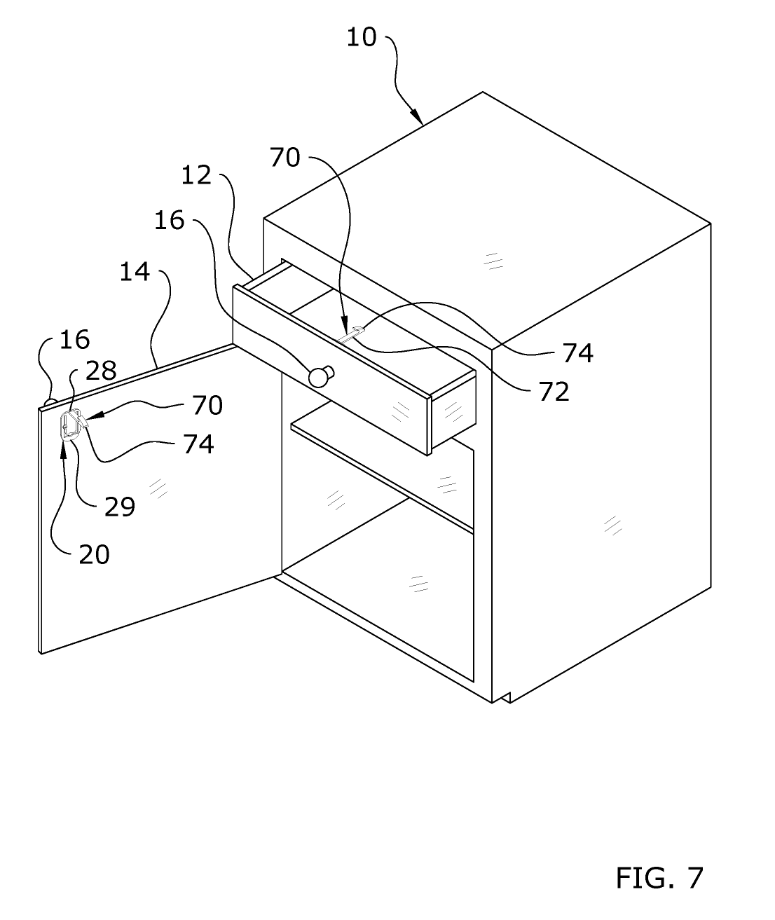

In another example embodiment shown in FIGS. 5 through 6b of the drawings, a first slot 50 extends through the outer surface 22 of the base 20 to the inner surface 24 of the base 20. The first slot 50 is elongated having a first end and a second end. The first slot 50 is preferably straight but may have various other shapes (e.g. curved, etc.). The first slot 50 is further preferably vertically aligned but may be angled or horizontally aligned.

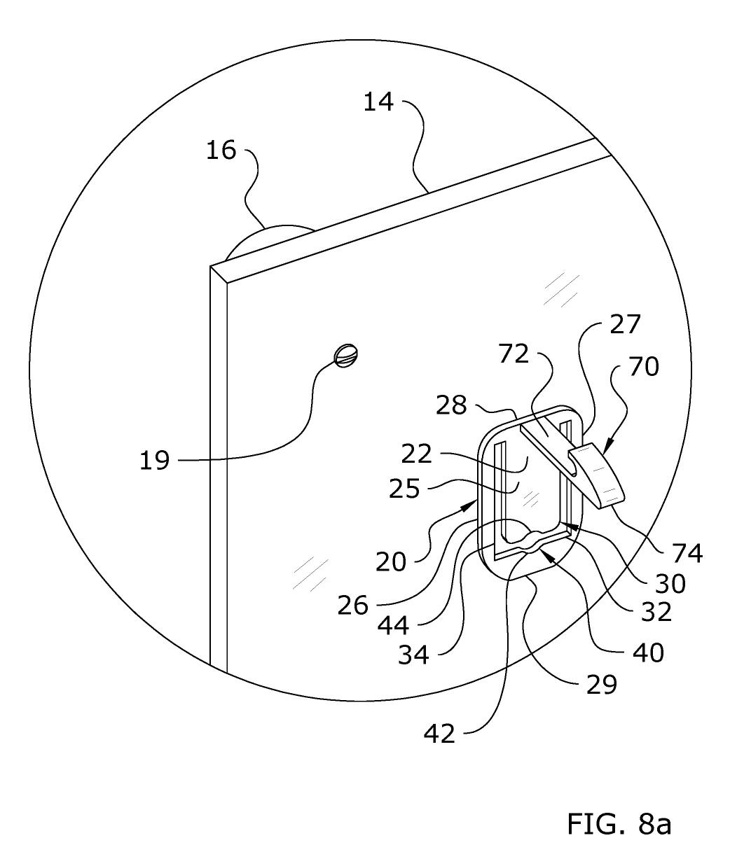

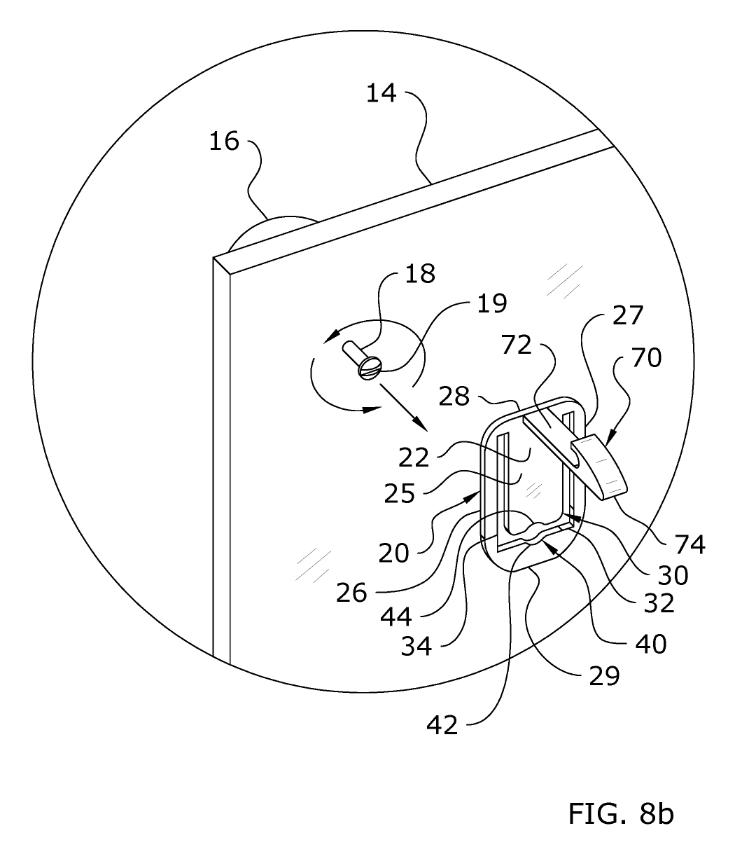

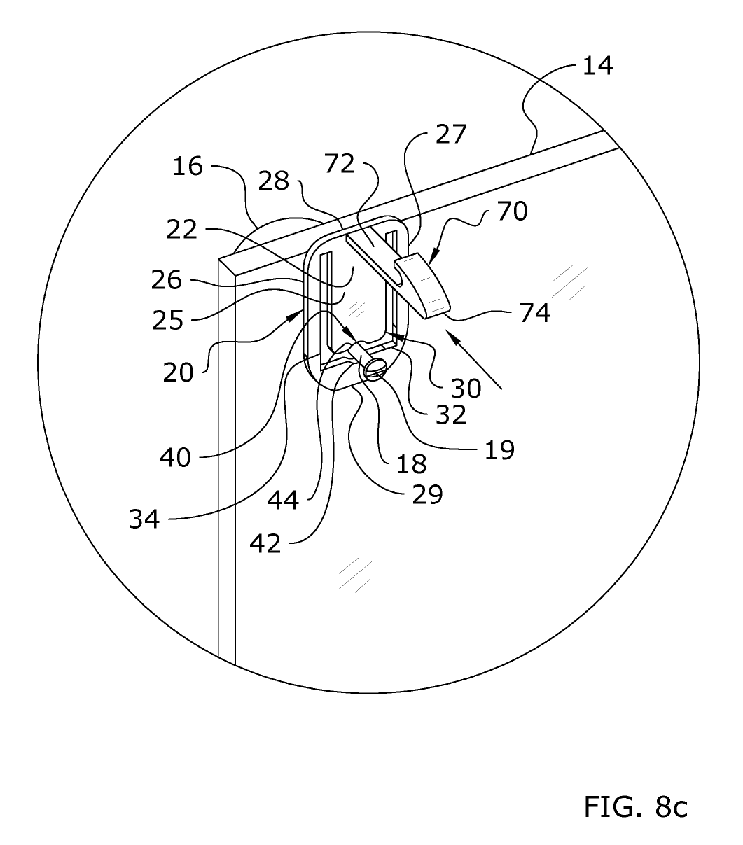

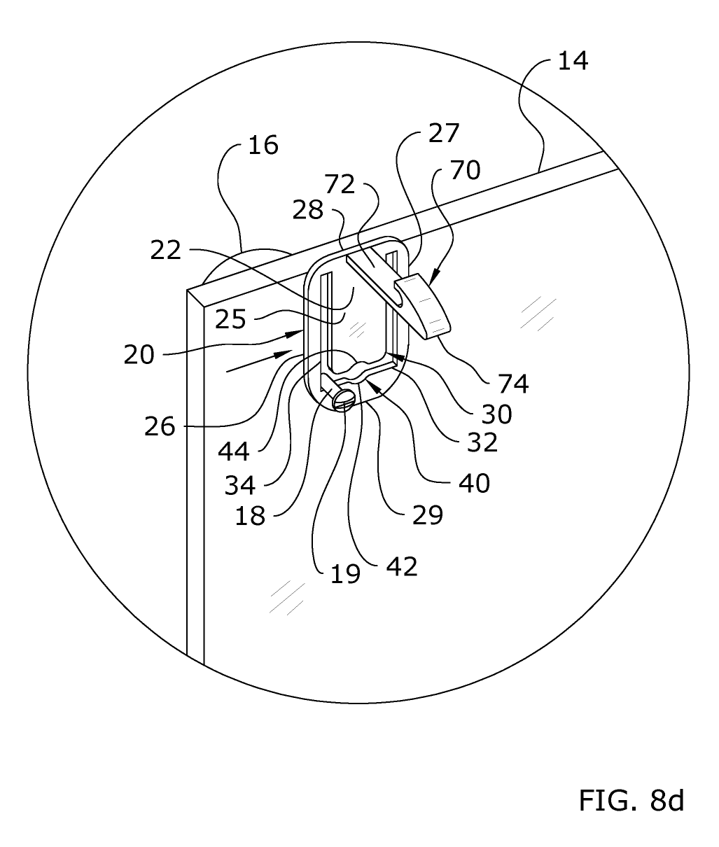

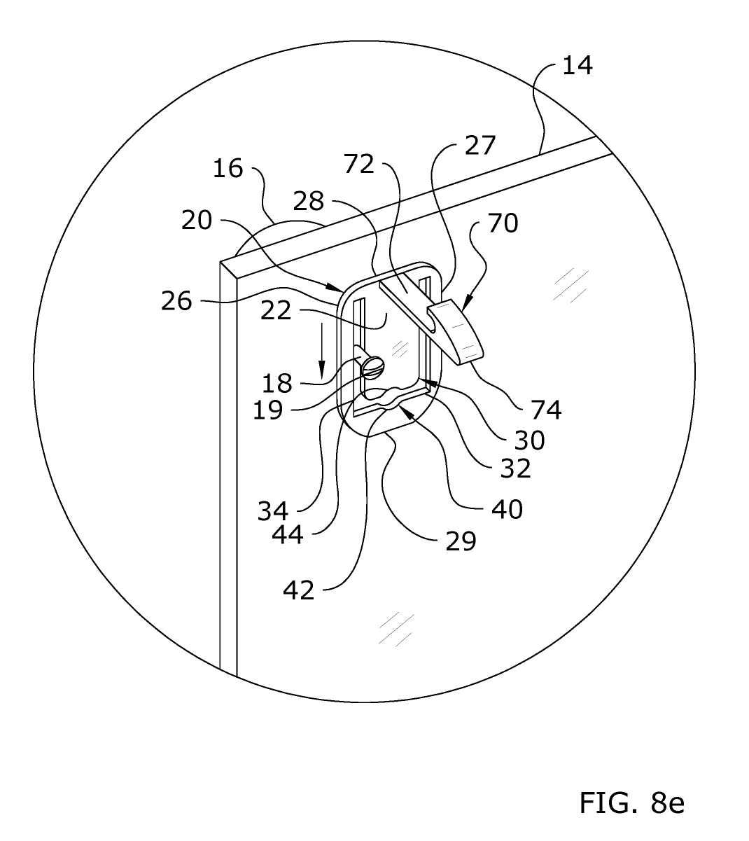

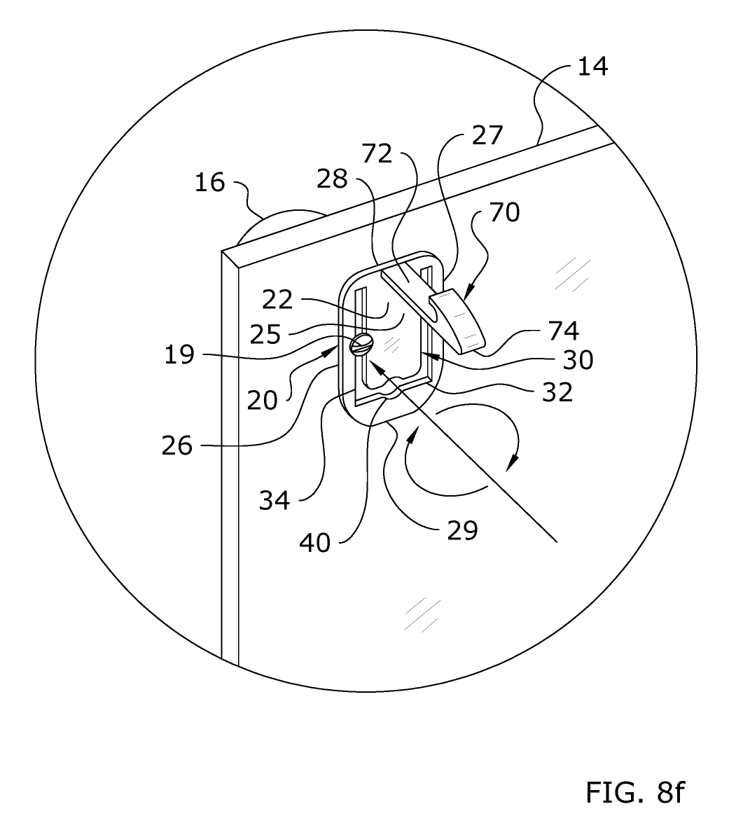

As further illustrated in the example embodiment of FIGS. 5 through 6b of the drawings, a first opening 52 extends through the outer surface 22 of the base 20 to the inner surface 24 of the base 20 and is connected to the first slot 50. The width of the first opening 52 is greater than the width of the first slot 50 and a width of a head 19 of a threaded fastener 18 to allow passage of the head 19 of the threaded fastener 18 through the first opening 52. The width of the first slot 50 is less than the width of the head 19 of the threaded fastener 18 to prevent passage of the head 19 of the threaded fastener 18 through the first slot 50 as illustrated in FIGS. 8c through 8f of the drawings.

The first opening 52 may extend through a portion of the first slot 50 between the first end and the second end of the first slot 50. In this embodiment, the first opening 52 may be comprised of a first cutout 42 extending into a first inner edge of the first slot 50 and a second cutout 44 extending into a second inner edge of the first slot 50 similar to the receiver opening 40 in the embodiment shown in FIGS. 1 through 2b of the drawings. In another alternative embodiment, the first opening 52 may be connected to the lower end, the upper end, left side or right side of the first slot 50. FIGS. 5 through 6b illustrate the first opening 52 connected to the first slot 50 at the lower end of the first slot 50, but as discussed the first opening 52 may be connected to various other locations along the first slot 50.

As further illustrated in the example embodiment shown in FIGS. 5 through 6b of the drawings, a second slot 60 extends through the outer surface 22 of the base 20 to the inner surface 24 of the base 20 in addition to the first slot 50. The second slot 60 is preferably not connected to the first slot 50 as illustrated, but the second slot 60 may be connected to the first slot 50. The first slot 50 and the second slot 60 are preferably parallel with respect to one another as illustrated in FIGS. 6a and 6b of the drawings, however, the first slot 50 and the second slot 60 may be positioned at angles with respect to one another. While a first slot 50 and a second slot 60 are shown in FIGS. 5 through 6b, it can be appreciated that only the first slot 50 or more than two slots may be used in various alternative embodiments.

The second slot 60 is elongated having a second end and a second end. The second slot 60 is preferably straight but may have various other shapes (e.g. curved, etc.). The second slot 60 is further preferably vertically aligned but may be angled or horizontally aligned.

As further illustrated in the example embodiment of FIGS. 5 through 6b of the drawings, a second opening 62 extends through the outer surface 22 of the base 20 to the inner surface 24 of the base 20 and is connected to the second slot 60. The width of the second opening 62 is greater than the width of the second slot 60 and a width of a head 19 of a threaded fastener 18 to allow passage of the head 19 of the threaded fastener 18 through the second opening 62. The width of the second slot 60 is less than the width of the head 19 of the threaded fastener 18 to prevent passage of the head 19 of the threaded fastener 18 through the second slot 60 as illustrated in FIGS. 8c through 8f of the drawings.

The second opening 62 may extend through a portion of the second slot 60 between the second end and the second end of the second slot 60. In this embodiment, the second opening 62 may be comprised of a first cutout 42 extending into a first inner edge of the second slot 60 and a second cutout 44 extending into a second inner edge of the second slot 60 similar to the receiver opening 40 in the embodiment shown in FIGS. 1 through 2b of the drawings. In another alternative embodiment, the second opening 62 may be connected to the lower end, the upper end, left side or right side of the second slot 60. FIGS. 5 through 6b illustrate the second opening 62 connected to the second slot 60 at the lower end of the second slot 60, but as discussed the second opening 62 may be connected to various other locations along the second slot 60. The openings 40, 52, 62 also are preferably circular (or otherwise circular shaped or forming a circular related shape in combination with the slots 30, 50, 60) along with sized to allow the head 19 of the threaded fastener 18 to pass through the openings 40, 52, 62.

### E. Example Embodiment

In one embodiment, the base 20 has a rectangular shape with a vertical length of approximately 2.5 inches and a horizontal width of 1.5 inches. The central portion 25 of the base 20 as shown in some embodiments preferably has a horizontal width of approximately 1 inch and a vertical length of approximately 2 inches. In this embodiment, the thickness is also preferably approximately ⅛ of an inch or less. As further part of this embodiment, the latch 70 preferably has a length of approximately 2.25 inches, a width of less than 0.5 inches and a thickness of approximately ⅛ of an inch. The first vertical slot 34 and the second vertical slot 36 are preferably equal in length and are approximately 2 inches in length. The horizontal slot 32 preferably has a length of approximately 1 inch. Furthermore, the distance between the inner surface 24 of the base 20 and the inner edge of the catch portion 76 of the latch 70 is preferably approximately 1.5 inches. The width of the slots 30, 50, 60 are preferably approximately ⅛ of an inch which is typically larger than a typical threaded fastener 18 used for a door 14 used on cabinetry, but the width may be greater or less. The width of the openings 40, 52, 62 is preferably approximately ⅜ of an inch or otherwise larger than the head 19 of the threaded fastener 18. This is only one exemplary embodiment and various other dimensions may be used for the various components depending upon the size of the cabinet 10, door 14 or drawer 12 and other situations.

### F. Operation of Preferred Embodiment

FIG. 7 provides a perspective view showing an embodiment attached to the interior of the door 14 and drawer 12 of a cabinet 10. FIGS. 8a through 8f illustrate one embodiment process to attach the base 20 to the door 14 or drawer 12 of a cabinet 10 without having to use a separate fastener. As shown in FIG. 8b, the user loosens the threaded fastener 18 used to secure the handle 16 to the door 14 or drawer 12 of the cabinet 10 with a conventional tool such as a screwdriver. After the threaded fastener 18 is loosened sufficiently (e.g. the distance of the inner part of the head 19 is greater than the thickness of the base 20), the user then aligns one of the openings 40, 52, 62 with the head 19 of the threaded fastener 18 and passes the head 19 of the threaded fastener 18 through the selected opening 40, 52, 62 as shown in FIG. 8c of the drawings. After the head 19 of the threaded fastener 18 has passed through the selected opening 40, 52, 62, the user then moves the base 20 (e.g. horizontally, vertically, etc.) with respect to the threaded fastener 18 so that the latch 70 is positioned in a manner to automatically engage the cabinet 10 when the door 14 or drawer 12 are closed (and to allow for release of the latch 70 from the cabinet 10 by the user to open the door 14 or drawer 12) as shown in FIGS. 8d and 8e of the drawings. As the base 20 is moved upon the threaded fastener 18, the corresponding slot 30, 50, 60 slides about the shaft portion of the threaded fastener 18 beneath the head 19 of the fastener wherein the head 19 is wider than the corresponding slot 30, 50, 60 thereby preventing the base 20 from leaving the threaded fastener 18 when not aligned with one of the openings 40, 52, 62. Once the base 20 is properly positioned on the threaded fastener 18 so the latch 70 is properly aligned with the cabinet 10, the user then tightens the threaded fastener 18 with a conventional tool such as a screwdriver as shown in FIG. 8f of the drawings. Once the base 20 is properly secured with the threaded fastener 18 used for the handle 16 of the door 14 or drawer 12, the latch 70 selectively engages the inner lip 11 of the cabinet 10 when the door 14 or drawer 12 is closed as illustrated in FIG. 9a of the drawings. When a child or other individual tries to open the door 14 or drawer 12, the latch 70 engages the inner lip 11 of the cabinet 10 to prevent the fully opening of the door 14 or drawer 12. If an authorized individual (e.g. adult) desires to open the door 14 or drawer 12 of the cabinet 10, they simply push down (or to the side depending upon the orientation of the latch 70) on the tongue 72 of the latch 70 to push the tongue 72 and the catch portion 76 downwardly away from the inner lip 11 of the cabinet 10. The authorized individual is then able to fully open the door 14 or drawer 12 to access the corresponding contents of the cabinet 10. To remove the base 20 and latch 70 from the door 14 or drawer 12, the user simply reverses the installation process shown in FIGS. 8a through 8f of the drawings thereby leaving the door 14 or drawer 12 without any damage or markings.

Unless otherwise defined, all technical and scientific terms used herein have the same meaning as commonly understood by one of ordinary skill in the art to which this invention belongs. Although methods and materials similar to or equivalent to those described herein can be used in the practice or testing of the childproof cabinet latch system, suitable methods and materials are described above. All publications, patent applications, patents, and other references mentioned herein are incorporated by reference in their entirety to the extent allowed by applicable law and regulations. The childproof cabinet latch system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A safety latch for a cabinet, comprising:
a base having an outer surface, an inner surface opposite of the outer surface, a first side portion, a second side portion opposite of the first side portion, an upper portion, and a lower portion opposite of the upper portion;
a latch extending outwardly from the base, wherein the latch includes a catch portion that is adapted to catchably engage an interior surface of a cabinet surrounding an opening in the cabinet;
a first slot extending through the outer surface of the base to the inner surface of the base, wherein the first slot is elongated having a first end and a second end; and
a first opening extending through the outer surface of the base to the inner surface of the base, wherein the first opening is connected to the first slot;
wherein the width of the first opening is greater than the width of the first slot, wherein the width of the first opening is greater than a width of a head of a threaded fastener to allow passage of the head of the threaded fastener through the first opening, and wherein the width of the first slot is less than the width of the head of the threaded fastener to prevent passage of the head of the threaded fastener through the first slot.

2. The safety latch of claim 1, wherein the base is comprised of a flat plate structure.

3. The safety latch of claim 2, wherein the base is comprised of a rectangular shape.

4. The safety latch of claim 3, wherein a length of the base measured from a lower edge to an upper edge is greater than a width of the base measured from a first side edge to a second side edge.

5. The safety latch of claim 1, wherein the base and latch are comprised of a plastic material.

6. The safety latch of claim 1, wherein the latch extends outwardly from the outer surface of the base.

7. The safety latch of claim 1, wherein the first slot is comprised of a straight slot.

8. The safety latch of claim 1, wherein the first slot is vertically aligned.

9. The safety latch of claim 1, wherein the first slot is horizontally aligned.

10. The safety latch of claim 1, wherein the first slot is comprised of a U-shaped slot having a horizontal slot, a first vertical slot and a second vertical slot, wherein the horizontal slot is connected between the first vertical slot and the second vertical slot.

11. The safety latch of claim 10, wherein the first opening is connected to the horizontal slot.

12. The safety latch of claim 11, wherein the first opening is connected to a central portion of the horizontal slot.

13. The safety latch of claim 11, wherein the first opening is comprised of a lower cutout extending into a lower edge of the horizontal slot and an upper cutout extending into an upper edge of the horizontal slot.

14. The safety latch of claim 13, wherein the upper cutout mirrors the lower cutout.

15. The safety latch of claim 1, wherein the first opening extends through a portion of the first slot between the first end and the second end of the first slot.

16. The safety latch of claim 15, wherein the first opening is comprised of a first cutout extending into a first inner edge of the first slot and a second cutout extending into a second inner edge of the first slot.

17. The safety latch of claim 16, wherein the first cutout mirrors the second cutout and wherein the first cutout is in opposition to the second cutout.

18. The safety latch of claim 1, including:
a second slot extending through the outer surface of the base to the inner surface of the base, wherein the second slot is elongated having a first end and a second end; and
a second opening extending through the outer surface of the base to the inner surface of the base, wherein the second opening is connected to the second slot;
wherein the width of the second opening is greater than the width of the second slot, wherein the width of the second opening is greater than a width of the head of the threaded fastener to allow passage of the head of the threaded fastener through the second opening, and wherein the width of the second slot is less than the width of the head of the threaded fastener to prevent passage of the head of the threaded fastener through the second slot.

19. The safety latch of claim 18, wherein the first slot is not connected to the second slot.

20. The safety latch of claim 18, wherein the first opening is connected to the first end of the first slot and wherein the second opening is connected to the first end of the second slot.
